(19) United States
(12) Patent Application Publication
(10) Pub. No.: US 2007/0255937 A1
(43) Pub. Date: Nov. 1, 2007

(54) Basic input / output system (BIOS) set-value access method

(76) Inventor: Sheng-Hsin Lo, Taipei (TW)

Correspondence Address: RABIN & Berdo, PC, 1101 14TH STREET, NW, SUITE 500, WASHINGTON, DC, 20005, US

(21) Appl. No.: 11/411,102

(22) Filed: Apr. 26, 2006

(51) Int. Cl. G06F 9/00

(52) U.S. Cl. 713/2

(57) ABSTRACT

A basic input/output system set-values access method, using the following steps: ascertaining it is indeed required to proceed with a basic input/output system set-value adjustment operation; adjusting more than one of the set-values of the basic input/output system; ascertaining the completion of the adjustment of all the set-values required; obtaining the data access address of the read-only-memory of the basic input/output system, and writing the various set-values of the basic input/output system into the read-only-memory according to the data access address.

### BACKGROUND

1. Field of the Invention

The invention relates to a system set-value access method and in particular to a basic input/output system (BIOS) set-value access method.

2. Related Art

In general, the set values of a basic input/output system, such as a real time clock (RTC), are set and stored in a built-in CMOS RAM (Complementary Metal Oxide Semiconductor Random Access Method) disposed on the main machine board during the system power-up, with a memory capacity of 128˜256 bytes. Usually, the set-values of the basic input/output system include: date, time, settings of disk drive and hard ware time sequence, operation voltage/frequency of CPU, set-values of the protection temperature, memory information, user password, setting of power management functions, and settings of chipset specifics, etc. Through the application and regulation of the various above-mentioned set-values, the user is able to maintain normal operation of the computer system, and optimize the operations of the computer system.

When the computer system is power-down, the power required by CMOS RAM is provided by the battery on the main-machine-board. Though the power consumed by CMOS RAM is minimal, yet with the progress of time, it will drain the power of the battery. When the power of the battery on the main-machine-board is used up, it will cause the loss of the set-values and thus affect the normal operation of the computer system, so that users are required to perform the set-value adjustment operation again. However, the categories of the set-value items of the basic input/output system are quite enormous, and they must be set and adjusted one-by-one. As such, unless the user is sufficiently familiar with the conditions/requirements of the various hardware devices of the computer system, thus is able to set and adjust the various set-values by himself, most of the users opt to read and utilize the values preset in the CMOS RAM by the manufacturer. However, these preset values are not the values which can be utilized to optimize the functions of the computer system, so that under this condition, the computer system is not able to produce its best performance.

Therefore, the research and development of a basic input/output system set-value access method, which is capable of maintaining the various set-values of the basic input/output system while the power of the battery on the main-machine-board is used up, is the most important and urgent task in this field.

### SUMMARY OF THE INVENTION

In view of the above-mentioned problems and shortcomings of the prior art, the object of the invention is to provide a basic input/output system set-value access method, through which the values set by the basic input/output system are written into CMOS RAM by making use of the data storage characteristics of the read only memory, thus solving the problem of losing the basic input/output system set-values when the power of the battery on the main-machine-board is used up.

Therefore, to achieve the above-mentioned objective, the invention provides a basic input /output system set-values access method, including the following steps: Firstly, verify and make sure if it is indeed required to proceed with the basic input/output system set-value adjustment operation. If the answer if affirmative, proceed with the adjustment of more than one set-value of the basic input/output system (for example, CMOS setting, chipset setting, power management setting, plug-and-run and peripheral element connection interface configuration settings, central processor unit speed/frequency/operation voltage settings, system actuation sequence setting, computer hardware password setting, user password setting, hard disk automatic detection setting etc.). Verify and ascertain the completion of adjustment of all the set values required. Obtain the data access address of the read only memory (for example, the electrical-erasable-programmable read-only-memory (EEPROM) or the flash memory) of the basic input/output system. And finally write (burn) the various set values of the basic input/output system into the read-only-memory (ROM) according to the data access address.

In the above-mentioned process, if at the beginning it is verified that it is not required to proceed with the basic input/output system set-value adjustment operation, then the process further comprises the following steps: obtain the data access address of the read-only-memory of the basic input/output system and the various set values required from the read-only-memory of the basic input/output system.

Therefore, through the application of the basic input/output system set-value access method, the data of the set-values of the basic input/output system are written into the specific addresses of the read-only-memory (ROM), and during the power-up process, the computer system is instructed to read the set-value data from the specific addresses of ROM, thus solving the problem of losing the basic input/output system set values when the power of the battery on the main-machine-board is used up.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention.

FIG. 1A is a schematic diagram of accessing the basic input/output system set-values according to the first embodiment of the invention;

FIG. 1B is a schematic diagram of accessing the basic input/output system set-values according to the second embodiment of the invention;

FIG. 2 is a flowchart of a method of accessing the basic input/output system set-values according to an embodiment of the invention;

FIG. 3A is a flowchart of the steps of reading the basic input/output system set-values according to an embodiment of the invention; and

FIG. 3B is a flowchart of the steps of writing the basic input/output system set-values according to an embodiment of the invention

### DETAILED DESCRIPTION OF THE INVENTION

The purpose, construction, features, and functions of the invention can be appreciated and understood more thoroughly through the following detailed description with reference to the attached drawings.

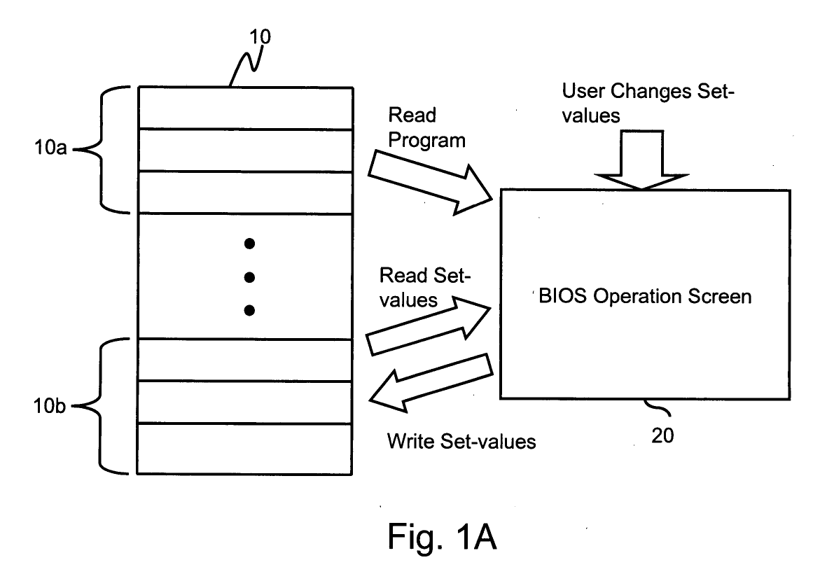

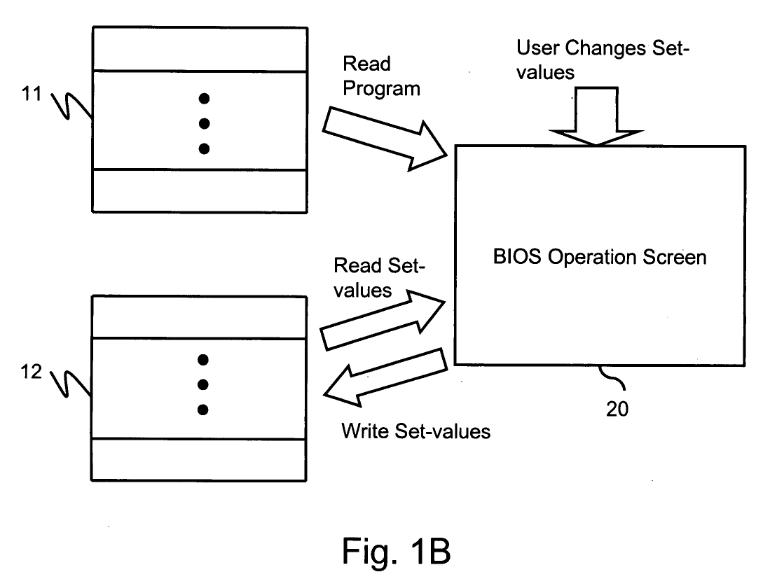

Refer to FIG. 1A, which shows a schematic diagram of accessing the basic input/output system set-values according to the first embodiment of the invention. As shown in FIG. 1A, the read-only-memory (ROM) 10 of the basic input/output system is partitioned into at least two memory blocks, including a first memory block 10a and a second memory block 10b, wherein, the first memory block 10a is stored with the program of the basic input/output system, while the second memory block 10b is stored with the set-values of the basic input/output system. The ROM 10 may be made of EEPROM or Flash ROM. In addition, the data stored in the respective memory blocks can be exchanged. Namely, the program of the basic input/output system may be stored in the second memory block 10b, and the set-values of the basic input/output system may be stored in the first memory block 10a without affecting the implementation of data accessing and its results.

Upon pressing the actuation key (usually assigned as the DEL key of the keyboard) by the user in the power-up process, the computer system starts executing the program of the basic input/output system, and displays the corresponding BIOS operation screen 20, so that the user may proceed with the revision and adjustment of the various set-values through the operation screen 20 of the basic input/output system. Upon finishing adjusting the various set-values, the computer system writes them into the second memory block 10b of the ROM 10. As such, even when the power of the battery on the main-machine-board is used up, the user only has to enter the data of time and date (the data of time and date are variable, and thus are not required to be written into the read-only-memory 10) and thus be able to successfully start the computer system.

Next, refer to FIG. 1B, which shows a schematic diagram of accessing the basic input/output system set-values according to the second embodiment of the invention. As shown in FIG. 1B, the difference between the first embodiment and the second embodiment is that two separate read-only-memories, namely, read-only-memory 11 and read-only-memory 12 are utilized in the second embodiment. The first read-only-memory 11 is stored with the program of the basic input/output system, while the second read-only-memory 12 is stored with the set-values of the basic input/output system. The first read-only-memory 11 and the second read-only-memory 12 may be made of EEPROM or Flash ROM. In addition, the data stored in the respective memory blocks are exchangeable. Namely, the program of the basic input/output system may be stored in the second read-only-memory 12, and the set-values of the basic input/output system may be stored in the first read-only-memory 11 without affecting the implementation of data accessing and its results.

The implementation of the adjustment of the set-values of the basic input/output system in the second embodiment is the same as that in the first embodiment, and will not be repeated here for brevity's sake.

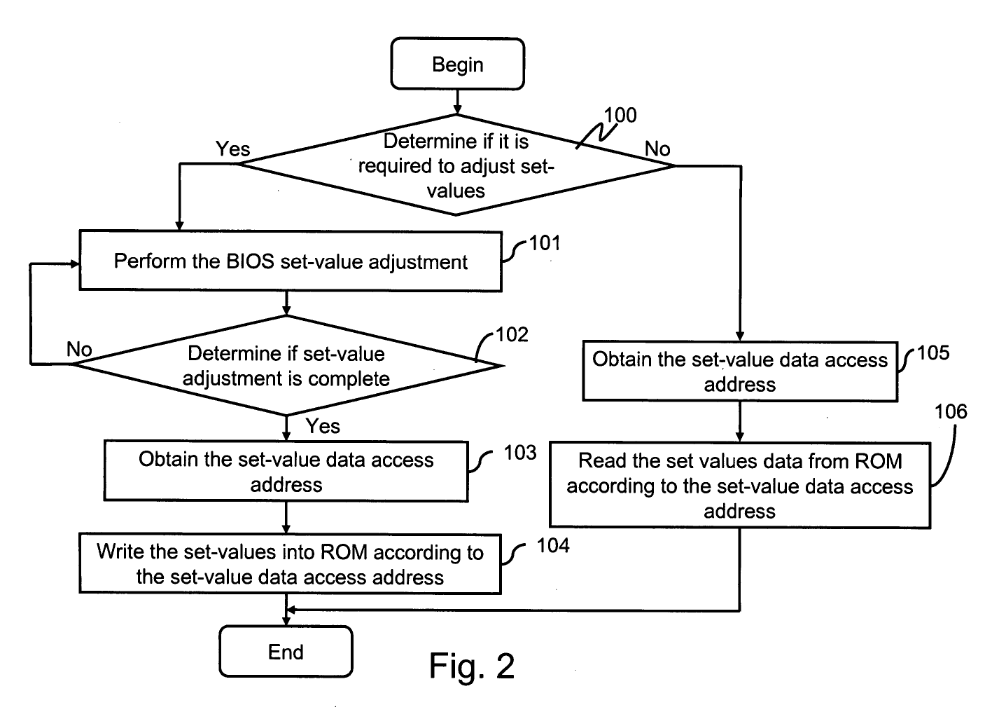

Subsequently, refer to FIG. 2, which shows a flowchart of a method of accessing the basic input/output system set-values according to an embodiment of the invention, including the following steps: Firstly, verify and make sure if it is indeed required to proceed with the basic input/output system set-value adjustment (step 100), and this is determined if the actuation key (usually the DEL key in the keyboard) is pressed during the power-up process. If the answer if affirmative, then proceed with the adjustment of the set-values of the basic input/output system (step 101), thus the user may adjust more than one set-value of the basic input/output system according to the actual conditions of hardware devices of the computer system, as such the various set-values are compatible with the actual conditions of the hardware devices, so that the computer system can function normally and efficiently. The set-values are selected from the group consisting of: a CMOS setting (for example: the information about time, date, hard disk, floppy disk drive, display model, and main memory), chipset setting, power management setting, plug-and-run and peripheral element connection interface configuration settings, central processor unit speed/frequency/operation voltage settings, a system actuation sequence setting, computer hardware password setting, user password setting, hard disk automatic detection setting, etc. Subsequently, verify and ascertain the completion of adjustment of all the set-values required (step 102). If the answer is negative, then go back to step 101 to continue the adjustment of the set-values of the basic input/output system.

Upon verifying finishing the set-values adjustment, first obtain the access address of the set-value data in the read-only-memory 10 (step 103). Then write (burn) the set-value data into the read-only-memory according to the access address of the set-value data (step 104). However, when in the beginning it is ascertained that the set-value adjustment process is not required and thus is not performed, then obtain the set-value data access address of the read-only-memory 10 (step 105). Subsequently, read the set-value data from the read-only-memory according to the set-value data access address (step 106), thus continuing to proceed with the power-up process of the computer system.

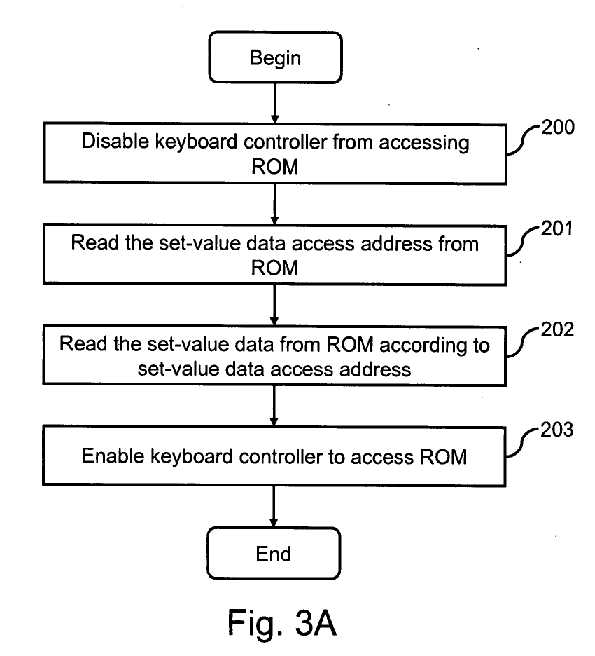

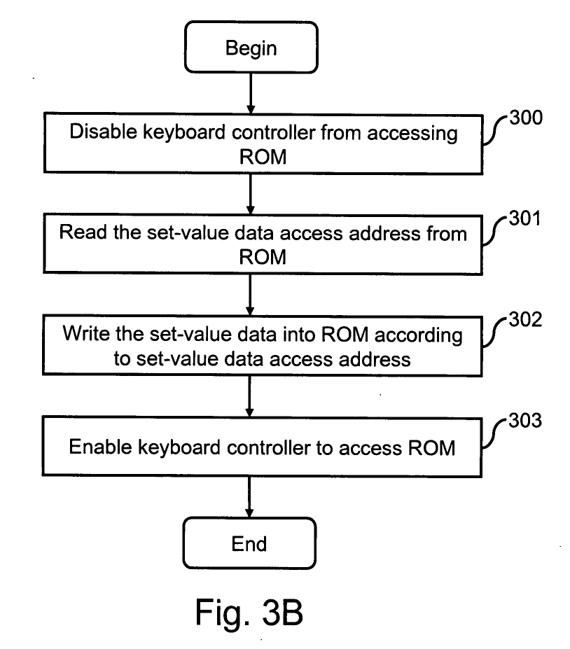

Then, refer to FIG. 3A, which shows a flowchart of the steps of reading the basic input/output system set-values according to an embodiment of the invention, including the following steps: Firstly, disable the keyboard controller (KBC) of the computer system from accessing the read-only-memory 10 of the basic input/output system (step 200). Next, read and obtain the set-value data access address from the read-only-memory by making use of the keyboard controller (step 201). Then, read out the set-value data from the read-only-memory 10 according to the set-value data access address by means of the keyboard controller (step 202). Subsequently, enable the keyboard controller of the computer system to access the read-only-memory 10 of the basic input/output system (step 203).

Finally, refer to FIG. 3B for a flowchart of the steps of writing the basic input/output system set-values according to an embodiment of the invention, including the following steps: Firstly, disable the keyboard controller (KBC) of the computer system by accessing the read-only-memory 10 of the basic input/output system (step 300). Or: prevent the keyboard controller from . . . . ? Next, read and obtain the set-value data access address from the read-only-memory by making use of the keyboard controller (step 301). Then, write (burn) the set-value data into the read-only-memory 10 according to the set-value data access address by means of the keyboard controller (step 302). Subsequently, enable the keyboard controller of the computer system to access the read-only-memory 10 of the basic input/output system (step 303).

Therefore, through the application of the basic input/output system set-value access method, the data of the set-values of the basic input/output system is written into the specific address of the read-only-memory (ROM), and during the power-up process, the computer system is instructed to read and obtain the set-value data from the specific addresses of ROM for use in the system initialization, thus solving the problem of losing the basic input/output system set values when the power of the battery on the main-machine-board is used up.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is

1. A basic input/output system set-values access method, comprising the following steps:
ascertaining it is indeed required to proceed with the basic input/output system set-value adjustment operation;
adjusting more than one of said set-values of said basic input/output system; ascertaining the completion of the adjustment of all the set-values required;
obtaining the data access address of the read-only-memory of said basic input/output system; and
writing said various set-values of said basic input/output system into said read-only-memory according to said data access address.

2. The basic input/output system set-values access method as claimed in claim 1, wherein
when ascertaining it is not required to proceed with said basic input/output system set-value adjustment operation, then proceed with the following steps;
obtaining the data access address of said read-only-memory of said basic input/output system; and
reading and obtaining said respective set-values from said read-only-memory of said basic input/output system according to said data access address.

3. The basic input/output system set-values access method as claimed in claim 1, wherein
said respective set-values are written into said read-only-memory by means of a keyboard controller (KBC).

4. The basic input/output system set-values access method as claimed in claim 1, wherein
said read-only-memory is an electrical-erasable-programmable read-only-memory (EEPROM).

5. The basic input/output system set-values access method as claimed in claim 1, wherein
said read-only-memory is a flash memory (Flash ROM).

6. The basic input/output system set-values access method as claimed in claim 1, wherein
said respective set-values are written into said read-only-memory by means of burning.

7. The basic input/output system set-values access method as claimed in claim 1, wherein
said respective set-values are selected from the group comprising of : CMOS setting, chipset setting, power management setting, plug-and-run and peripheral element connection-interface configuration settings, central processor unit speed/frequency/operation voltage settings, system actuation sequence setting, computer hardware password setting, user password setting, and hard disk automatic detection setting.
